(19) United States
(12) Patent Application Publication
(10) Pub. No.: US 2021/0224001 A1
(43) Pub. Date: Jul. 22, 2021

(54) STORAGE CONTROLLER, STORAGE SYSTEM, AND INFORMATION PROCESSING SYSTEM

(71) Applicant: SONY CORPORATION, TOKYO (JP)

(72) Inventor: YUTO HOSOGAYA, TOKYO (JP)

(21) Appl. No.: 17/250,668

(22) PCT Filed: May 17, 2019
(86) PCT No.: PCT/JP2019/019691

§ 371 Date: Feb. 17, 2021

(30) Foreign Application Priority Data
Aug. 30, 2018 (JP) 2018-161916

(51) Int. Cl. G06F 3/06

(52) U.S. Cl. CPC G06F 3/0659; G06F 3/0652; G06F 3/0673; G06F 3/0604; G06F 3/0647

(57) ABSTRACT

The efficiency of processing is increases even in a case where an area release notification issued to expressly specify release of an unnecessary area from a host side is inconsistent with a management unit of a storage. The storage controller receives at least one area release request for the storage from a host computer. Until predetermined conditions are met after the receipt of the area release request, the storage controller causes the storage to suspend a process on the area release request. When the predetermined conditions are met, the storage controller causes the storage to execute the process on the area release request.

### TECHNICAL FIELD

The present technology relates to a storage controller. More specifically, the present technology relates to a storage controller, storage system, and information processing system that manage a storage area.

### BACKGROUND ART

A NAND flash memory used for an SSD (Solid State Drive) is unable to physically overwrite data. Accordingly, when a write operation is to be performed with respect to a used block of a storage in which an SSD having a NAND flash memory is used, it is necessary to copy currently used data, write the copied data into an unoccupied block, and delete data in an original block. In order to increase the efficiency of such processing, an area release notification (e.g., TRIM command) is used for expressly specifying the release of an unnecessary area from a host side (refer, for example, to PTL 1). This makes it possible to improve the performance and lifespan of the storage.

Meanwhile, the size of an area to be released from the host side generally differs from the size of a management unit on a storage side. Therefore, there may arise a case where only a part of the management unit in the storage is to be released. In such a case, the management unit cannot be entirely released. This causes a handling problem. In view of such circumstances, there is proposed a memory system for performing a rewrite, in a case where a release target is smaller than a storage management unit, by overwriting a released portion with the same data (e.g., “0”) as an erased state to make the released portion look like an erased portion (refer, for example, to PTL 2).

### CITATION LIST

### Patent Literature

### [PTL 1]

Japanese Patent Laid-open No. 2009-237668

### [PTL 2]

Japanese Patent Laid-open No. 2012-203864

### SUMMARY

### Technical Problem

The above-described conventional technology is able to make the released portion look like the erased portion. However, it is not possible to release the release target from storage management. As a result, there still remains a possibility of performing an unnecessary copy process.

The present technology has been made in view of the above circumstances. An object of the present technology is to increase efficiency of processing even in a case where, when an area release notification to expressly specify release of an unnecessary area from a host side is to be issued, a release target is inconsistent with the storage management unit.

### Solution to Problem

In order to solve the above-described problem, according to a first aspect of the present technology, there are provided a storage controller, a storage system, and an information processing system. The storage controller, the storage system, and the information processing system each include a control section configured to, until predetermined conditions are met after receiving at least one area release request for a storage, cause the storage to suspend a process on the area release request and to cause the storage to execute the process on the area release request when the predetermined conditions are met. This produces an effect of causing the storage to suspend the process on the area release request until the predetermined conditions are met.

Further, in the first aspect, upon receiving a release request termination notification on the area release request, the control section may conclude that the predetermined conditions are met, and cause the storage to execute the process on the area release request. This produces an effect of causing the storage to execute the process upon receipt of the release request termination notification.

Furthermore, in the first aspect, when a predetermined period elapses after the last receipt of the area release request, the control section may conclude that the predetermined conditions are met, and cause the storage to execute the process on the area release request. This produces an effect of causing the storage to execute the process when the predetermined period elapses after the last receipt of the area release request.

Moreover, in the first aspect, upon receiving a release request start notification on the area release request, the control section may cause the storage to suspend the process on the area release request until the predetermined conditions are met. This produces an effect of causing the storage to suspend the process on the area release request upon receipt of the release request start notification until the predetermined conditions are met.

Further, in the first aspect, the storage controller may further include a suspension process storage section configured to store the process in the storage that is suspended by the control section. This produces an effect of causing the suspension process storage section to store the suspended process in the storage.

Furthermore, in the first aspect, the storage controller may further include a management information retention section configured to manage a physical address in the storage, and the control section may release a target area in the management information retention section according to the area release request. This produces an effect of releasing the target area in the management information retention section upon the area release request.

Moreover, in the first aspect, the control section may cause the storage to suspend a process on a non-boundary area around an area to be released upon the area release request, the non-boundary area being inconsistent with a boundary of a management unit of the storage. This produces an effect of suspending the process on the non-boundary area.

Further, in the first aspect, the control section may cause the storage to resume the process on the non-boundary area when the predetermined conditions are met. This produces an effect of resuming the process on the non-boundary area when the predetermined conditions are met.

Furthermore, in the first aspect, the control section may cause the storage to execute a garbage collection process as the process on the area release request, the garbage collection process being a process of collecting currently used areas in the storage and moving the collected areas to another area.

### BRIEF DESCRIPTION OF DRAWINGS

FIG. 1 is a diagram illustrating an example of an overall configuration of an information processing system according to a first embodiment of the present technology.

FIG. 2 is a diagram illustrating an example configuration of an address conversion table 220 in an embodiment of the present technology.

FIG. 3 is a diagram illustrating an example of a logical block address list 190 for a TRIM command.

FIG. 4 is a diagram illustrating an example aspect of area release upon an area release request in an embodiment of the present technology.

FIG. 5 is a diagram illustrating an example of state transition upon the area release request in a first embodiment of the present technology.

FIG. 6 is a chart diagram illustrating an example flow of overall processing in the first embodiment of the present technology.

FIG. 7 is a flowchart illustrating an example of a processing procedure of a storage controller 200 according to the first embodiment of the present technology.

FIG. 8 is a diagram illustrating an example of state transition upon the area release request in a second embodiment of the present technology.

FIG. 9 is a sequence chart illustrating an example flow of overall processing in the second embodiment of the present technology.

FIG. 10 is a diagram illustrating an example of the overall configuration of the information processing system according to a third embodiment of the present technology.

FIG. 11 is a diagram illustrating an example of state transition upon the area release request in the third embodiment of the present technology.

FIG. 12 is a sequence chart illustrating an example flow of overall processing in the third embodiment of the present technology.

### DESCRIPTION OF EMBODIMENTS

Embodiments for implementing the present technology (hereinafter referred to as the embodiments) will now be described. A description will be given in the following order.

1. First embodiment (an example in which termination is notified by a TRIM request termination notification)

2. Second embodiment (an example in which start is notified by a TRIM request start notification)

3. Third embodiment (an example in which timeout of the TRIM request termination notification is detected)

### 1. First Embodiment

### (Information Processing System)

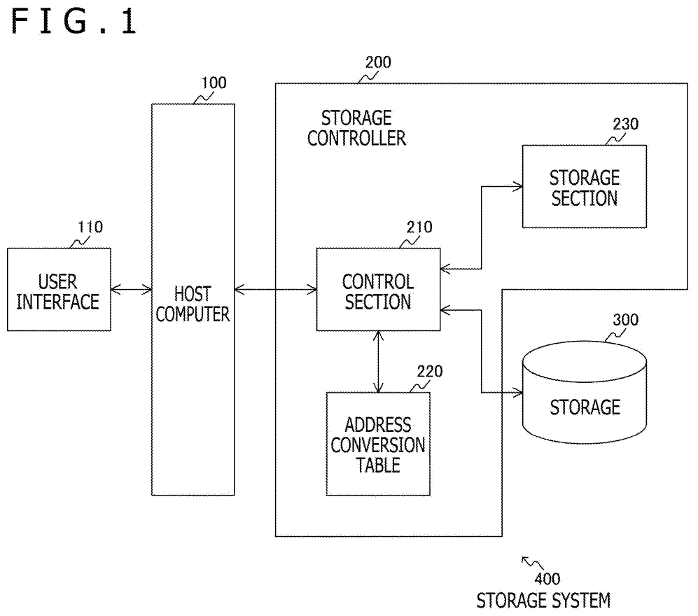

FIG. 1 is a diagram illustrating an example of an overall configuration of an information processing system according to a first embodiment of the present technology.

The information processing system includes a host computer 100, a storage controller 200, and a storage 300. The storage controller 200 and the storage 300 form a storage system 400.

The host computer 100 is a processing device that performs processing in the information processing system. The host computer 100 accesses the storage 300 as needed to perform a read or write operation. The host computer 100 includes a user interface 110 in order to receive an instruction inputted by a user and output, for example, images and sounds to the user.

The storage 300 is a storage device that uses a NAND flash memory or other nonvolatile memory as an SSD. Area management of the storage 300 is exercised by the storage controller 200.

The storage controller 200 is a control device that manages the storage 300. The storage controller 200 includes a control section 210, an address conversion table 220, and a storage section 230.

The control section 210 controls processing performed in the storage controller 200. The storage section 230 is a memory (RAM: Random Access Memory) that stores, for example, data required for processing by the control section 210. It should be noted that the storage section 230 is an example of a suspension process storage section described in the appended claims.

The address conversion table 220 is a conversation table that stores correspondence between a logical address and a physical address in order to convert the logical address specified by the host computer 100 to the physical address of the storage 300. It should be noted that the address conversion table 220 is an example of a management information retention section described in the appended claims.

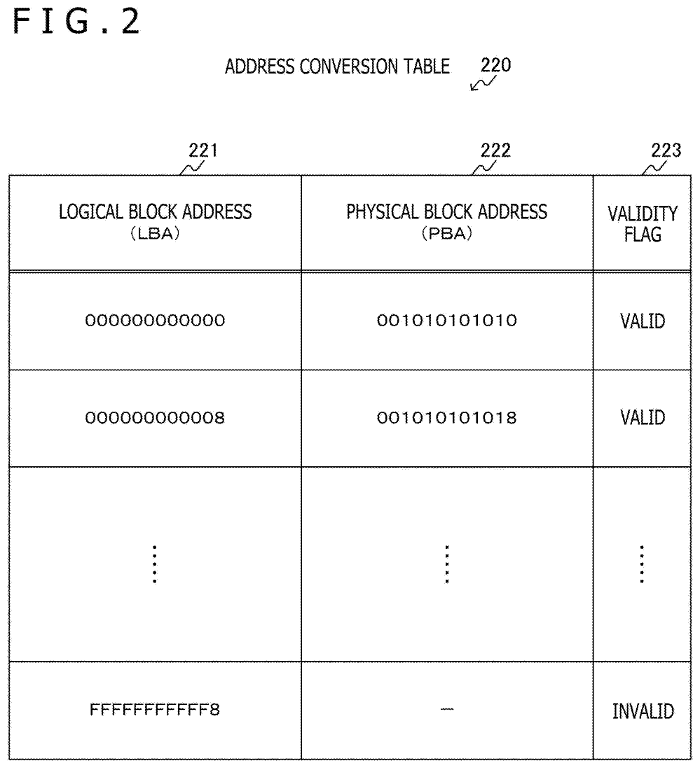

FIG. 2 is a diagram illustrating an example configuration of the address conversion table 220 in an embodiment of the present technology.

The address conversion table 220 stores, for each entry, correspondence between a block address of a logical address (LBA: Logical Block Address) 221 specified by the host computer 100 and a block address of a physical address (PBA: Physical Block Address) 222 of the storage 300. The control section 210 is able to convert the logical address to the physical address of the storage 300 by referring to the address conversion table 220.

The address conversion table 220 stores a validity flag 223 for each entry. The validity flag 223 indicates whether or not an address pair formed by the LBA 221 and PBA 222 to be stored for each entry is valid. Physical addresses not registered for valid entries in the address conversion table 220 are regarded as addresses pointing to an invalid area.

A write unit and an erase unit of a NAND flash memory which is assumed to be used as the storage 300 are different from each other. Therefore, when a capacity of a write destination is insufficient, valid data being present in the area having a currently used erase unit is copied to an area having another erase unit and then erased. This process is called a garbage collection. The control section 210 also forms a determination on the garbage collection, and determines, on the basis of the address conversion table 220, whether or not a data area is valid.

### (Area Release Request)

An operating system operates in the host computer 100 and issues an instruction to the storage 300 which is the storage device according to a user instruction issued through the user interface 110. According to storage/read process for data such as a file from the user, the storage controller 200 performs a write or read process on a storage area of the storage 300. In a case where no user instruction or application request is issued, a period of time for idling occurs because the host computer 100 does not issue any request to the storage 300. In order to respond to an instruction from the host computer 100 with low delay, the storage 300 performs the garbage collection spontaneously within itself during the period of time for the idling state.

When the user issues an instruction for deleting file or other data, the operating system erases the presence of a relevant file in a file system. However, even when the presence of a file in the file system is erased, the file remains at a logical address where the actual file is present. In such a case, the storage 300 is unable to determine that the file is deleted and rendered unnecessary. Therefore, the file is also handled as valid data within the storage 300 and thus targeted for garbage collection.

In order to avoid such an inconvenience, the operating system has a function of expressly notifying the storage 300 of a logical address where the file has been present when being deleted, as an unnecessary area. Such a notification is referred to as an area release request. The area release request is known, for example, as the TRIM command for ATA (Advanced Technology Attachment) or as the UNMAP command for SCSI (Small Computer System Interface). In addition, NVMe (Non-Volatile Memory Express) also has the similar function. The following describes an example in which the TRIM command is used as an example of the area release request.

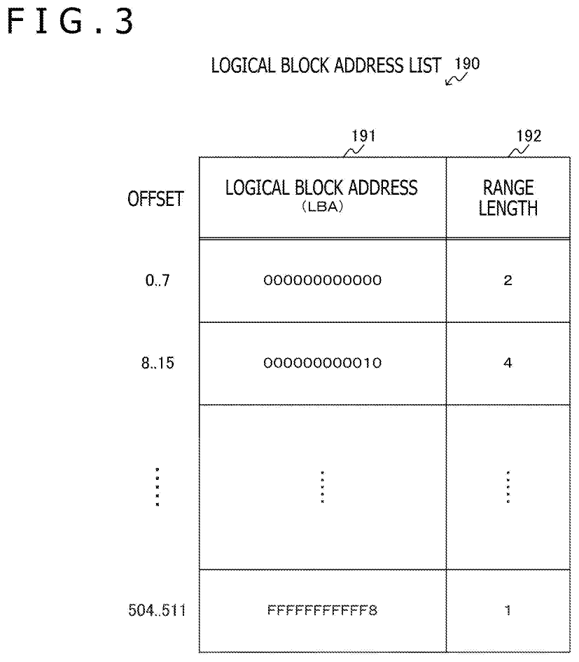

FIG. 3 is a diagram illustrating an example of a logical block address list 190 for the TRIM command.

The TRIM command (DATA SET MANAGEMENT command) for ATA specifies one or more logical block addresses (LBAs) as an unnecessary area. The logical block address list 190 is a list of unnecessary LBAs specified in the above instance. The logical block address list 190 is able to retain a total of 512 bytes of 64 entries. Each entry contains a 6-byte logical block address (LBA) 191 and a 2-byte range length 192.

The logical block address 191 is a value indicating the first logical block address of the unnecessary area. The range length 192 is the number (integer) of logical blocks specified as the unnecessary area. When the range length 192 is zero, the logical block address 191 of the associated entry is regarded as invalid. It should be noted that an offset represents the offset value for each byte in the list.

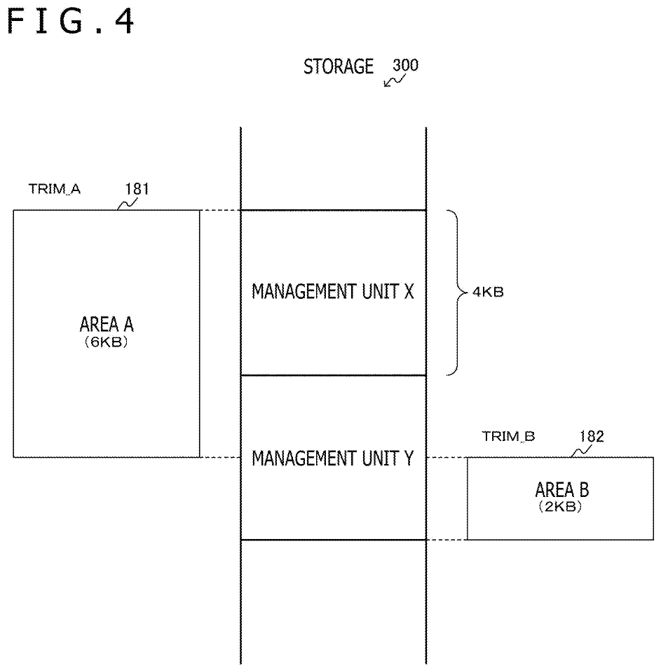

FIG. 4 is a diagram illustrating an example aspect of area release upon the area release request in an embodiment of the present technology.

Here, it is assumed that the management unit of the storage 300 is 4 KB. Meanwhile, the area specified by the area release request from the host computer 100 is an integer multiple of the LBA (e.g., 512 B) and is not always consistent with the management unit of the storage 300.

The present example assumes a case where the first TRIM command TRIM_A specifies a 6-KB area A (181) as an unnecessary area and the second TRIM command TRIM_B specifies a subsequent 2-KB area B (182) as an unnecessary area.

In a case where garbage collection is executed immediately when the TRIM command TRIM_A is requested, the relevant area can be released without making a copy of data because the whole area of a management unit X is unnecessary. Meanwhile, it is possible that valid data might be stored in the 2 KB latter half of a management unit Y. In this case, therefore, the valid data needs to be copied to another area. Further, the value zero needs to be written into an area regarded unnecessary in order to return zero when a read operation is performed.

However, the 2 KB latter half of the management unit Y is regarded as an unnecessary area by the second TRIM command TRIM_B. Therefore, the whole area of the management unit Y becomes an unnecessary area. As a result, the above-described processing is eventually in vain. In order to avoid such useless processing, the storage controller 200 according to the present embodiment stops execution of garbage collection after the TRIM command TRIM_A is issued, waits until the TRIM command TRIM_B is issued, and then executes the TRIM commands TRIM_A and TRIM_B together. In order to achieve such execution, the present embodiment issues a TRIM request termination notification from the host computer 100 to the storage controller 200 at a point of time when a series of requests for the TRIM commands are completely made. This enables the storage controller 200 to grasp a management unit that becomes wholly an unnecessary area, thereby avoiding unnecessary processing. It should be noted that the TRIM request termination notification is an example of a release request termination notification described in the appended claims.

### (State Management)

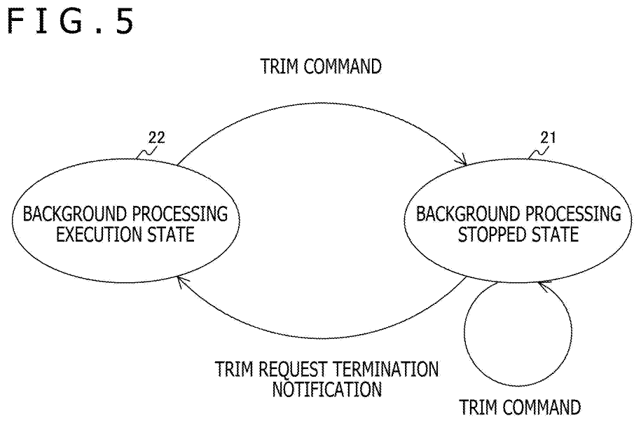

FIG. 5 is a diagram illustrating an example of state transition upon the area release request in the first embodiment of the present technology.

When, for example, garbage collection is initiated as described above while the series of requests for the TRIM commands are made, it is possible that useless processing might be performed. Therefore, a state where such processing can be executed and a state where such execution should be stopped are assumed to cause a state transition between such two states. Here, the above-described garbage collection process and a process (non-boundary process) performed on a non-boundary portion inconsistent with the boundary of a management unit of the storage 300 are collectively referred to as background processing.

A background processing stopped state 21 is a state waiting for a subsequent TRIM command. In the background processing stopped state 21, background processing is stopped. When a TRIM command is issued from the host computer 100 to the storage controller 200, the background processing stopped state 21 is maintained even after another TRIM command is issued. Subsequently, when the host computer 100 issues the TRIM request termination notification to the storage controller 200, the state transits to a background processing execution state 22.

The background processing execution state 22 is a state of waiting for no subsequent TRIM command. In the background processing execution state 22, the background processing can be executed, and a stopped background processing is resumed. When a new TRIM command is issued in the background processing execution state 22, the state transits to the background processing stopped state 21 and thus stops the background processing.

### (Operations)

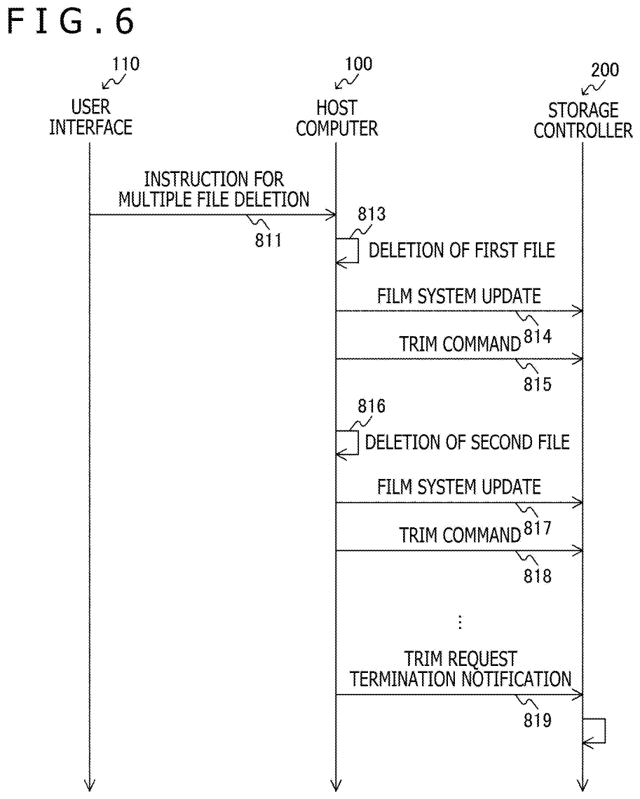

FIG. 6 is a sequence chart illustrating an example flow of overall processing in the first embodiment of the present technology.

When an instruction for multiple file deletion is issued through the user interface 110 (811), the operating system of the host computer 100 deletes files designated by the instruction for multiple file deletion (813, 816), and updates the file system (814, 817). Subsequently, an area where the files have been present is regarded as an unnecessary area, and a TRIM command is issued to the storage controller 200 (815, 818).

When the above processing is repeated to complete processing on all the files designated by the instruction for file deletion, the host computer 100 issues the TRIM request termination notification to the storage controller 200 (819). This causes the storage controller 200 to recognize the completion of the series of requests for the TRIM commands, and perform necessary background processing.

Upon receiving a TRIM command, the storage controller 200 updates the address conversion table 220. However, requests smaller than the management unit of the address conversion table 220 are stacked in the storage section 230 to suspend actual processing. Upon receiving the TRIM request termination notification, the storage controller 200 performs a process (non-boundary process) on requests that are inconsistent with the boundary of the management unit and stacked in the storage section 230.

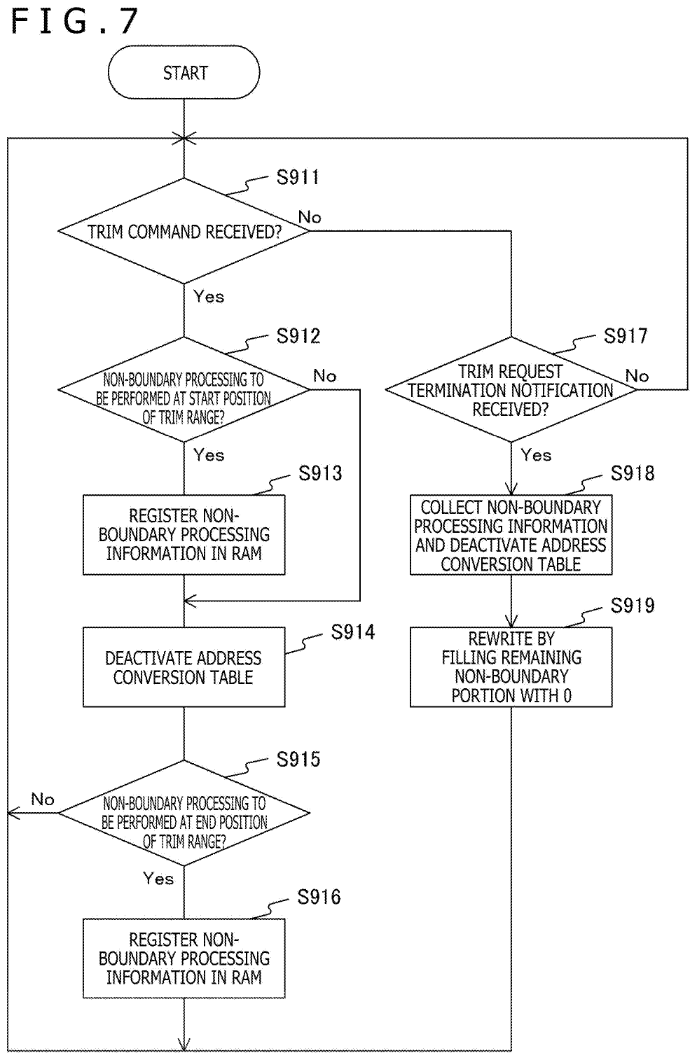

FIG. 7 is a flowchart illustrating an example of a processing procedure of the storage controller 200 according to the first embodiment of the present technology.

Upon receiving a TRIM command from the host computer 100 (“Yes” at step S911), the control section 210 determines whether or not a non-boundary process is to be performed on the start position of an area designated by the TRIM command (step S912). If the non-boundary process is to be performed (“Yes” at step S912), the control section 210 causes the storage section 230 (RAM) to register information regarding the non-boundary process (step S913).

According to the TRIM command from the host computer 100, the control section 210 releases (deactivates) the corresponding area of the address conversion table 220 (step S914).

Further, the control section 210 determines whether or not a non-boundary process is to be performed on the end position of the area designated by the TRIM command (step S915). If the non-boundary process is to be performed (“Yes” at step S915), the control section 210 causes the storage section 230 (RAM) to register information regarding the non-boundary process (step S916).

Meanwhile, upon receiving the TRIM request termination notification from the host computer 100 (“No” at step S911 and “Yes” at step S917), the control section 210 collects non-boundary processing information and releases (deactivates) the corresponding area of the address conversion table 220 (step S918). Subsequently, the control section 210 performs a rewrite operation by filling a remaining non-boundary portion with zero (step S919).

As described above, the first embodiment of the present technology enables the storage controller 200 to collectively handle a series of TRIM commands by issuing the TRIM request termination notification from the host computer 100. This makes it possible to avoid unnecessary processing on the non-boundary portion of the management unit of the storage 300, increase the efficiency of processing in the storage 300, and improve the performance and lifespan of the storage 300.

### 2. Second Embodiment

In the first embodiment described above, when starting to make the series of requests for the TRIM commands, the TRIM commands are issued without expressly giving an instruction. In contrast, in a second embodiment, when starting to make the series of requests for the TRIM commands, the host computer 100 issues a TRIM request start notification. This causes the storage controller 200 to recognize that the series of requests for the TRIM commands start and to stop the background processing. It should be noted that the TRIM request start notification is an example of a release request start notification described in the appended claims.

### (State Management)

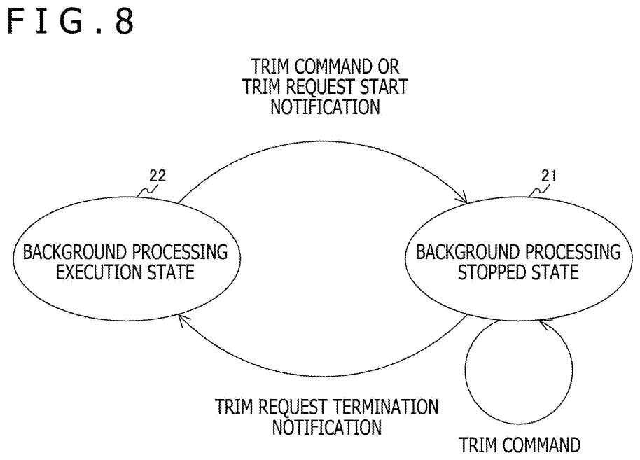

FIG. 8 is a diagram illustrating an example of state transition upon the area release request in the second embodiment of the present technology. It should be noted that the configuration of the information processing system according to the second embodiment as an underlying technique will not be described in detail because it is assumed to be similar to the configuration according to the first embodiment.

The second embodiment is similar to the first embodiment described above in that a state transition occurs between two states, namely, the background processing stopped state 21 and the background processing execution state 22. When the host computer 100 issues the TRIM request start notification to the storage controller 200 in the background processing execution state 22, the state transits to the background processing stopped state 21. In a case where the first TRIM command is issued before the issue of the TRIM request start notification, the state immediately transits to the background processing stopped state 21, as is the case with the first embodiment. The other state transitions are similar to those in the first embodiment described above.

### (Operations)

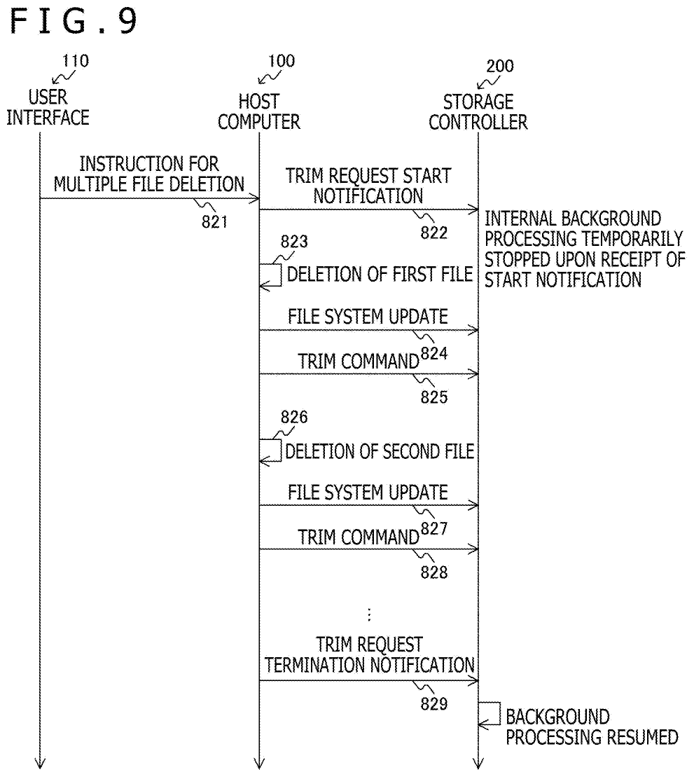

FIG. 9 is a sequence chart illustrating an example flow of overall processing in the second embodiment of the present technology.

When the instruction for multiple file deletion is issued through the user interface 110 (821), the host computer 100 issues the TRIM request start notification (822). Upon receiving the TRIM request start notification, the storage controller 200 temporarily stops its internal background processing.

Subsequently, the operating system of the host computer 100 deletes files designated (823, 826) and updates the file system (824, 827). Subsequently, an area where the files have been present is regarded as an unnecessary area, and a TRIM command is issued to the storage controller 200 (825, 828).

When the above processing is repeated to complete processing on all the files designated by the instruction for file deletion, the host computer 100 issues the TRIM request termination notification to the storage controller 200 (829). This causes the storage controller 200 to recognize the completion of the series of requests for the TRIM commands and resume the background processing.

As described above, in the second embodiment of the present technology, the host computer 100 issues the TRIM request start notification when starting to make the series of requests for the TRIM commands. This enables the storage controller 200 to recognize that the series of requests for the TRIM commands start before the issue of the TRIM commands and to stop the background processing.

### 3. Third Embodiment

The first and second embodiments assume that the host computer 100 issues the TRIM request termination notification. However, for some reason, the storage controller 200 might be unable to receive the TRIM request termination notification. In view of such circumstances, a third embodiment resumes stopped background processing when a predetermined period elapses after the last TRIM command or TRIM request start notification.

### (Information Processing System)

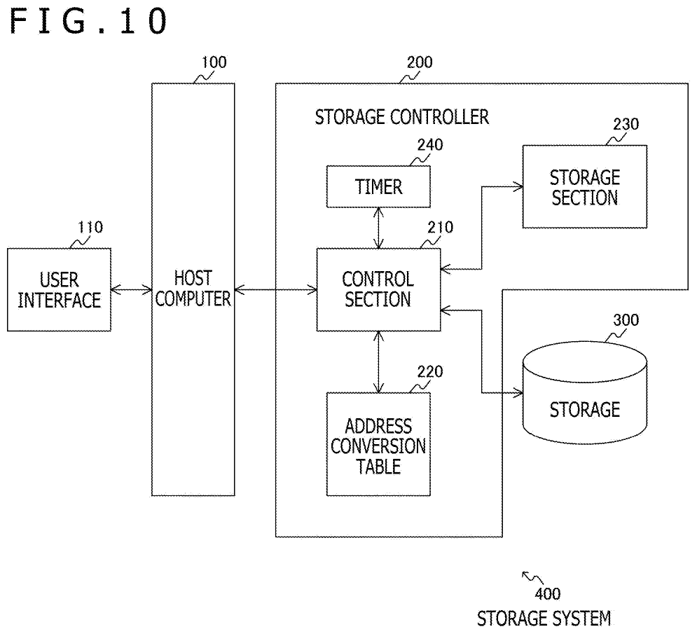

FIG. 10 is a diagram illustrating an example of an overall configuration of the information processing system according to the third embodiment of the present technology.

The information processing system according to the third embodiment differs from the information processing system according to the first embodiment described above in that the former includes a timer 240. The timer 240 counts the elapsed time from the point of time of receiving the last TRIM command or TRIM request start notification. When the timer 240 counts up to the predetermined period, the timer 240 notifies the control section 210 of the elapse of the predetermined period. This causes the control section 210 to detect a timeout and to resume the background processing which has been stopped.

### (State Management)

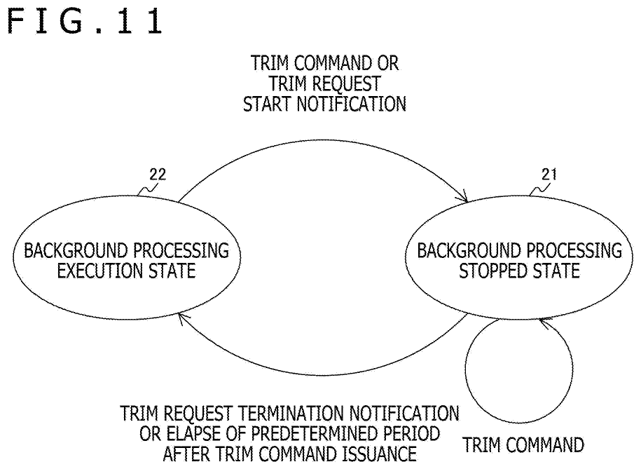

FIG. 11 is a diagram illustrating an example of state transition upon the area release request in the third embodiment of the present technology.

The third embodiment is also similar to the first and second embodiments described above in that a state transition occurs between two states, namely, the background processing stopped state 21 and the background processing execution state 22. When the host computer 100 issues the TRIM request termination notification to the storage controller 200 in the background processing stopped state 21, the state transits to the background processing execution state 22. However, if the timer 240 counts up to the predetermined period before the receipt of the TRIM request termination notification, the state transits to the background processing execution state 22. In other words, when the predetermined period elapses from the point of time of receiving the last TRIM command or TRIM request start notification, the state transits to the background processing execution state 22 in order to resume the background processing.

### (Operations)

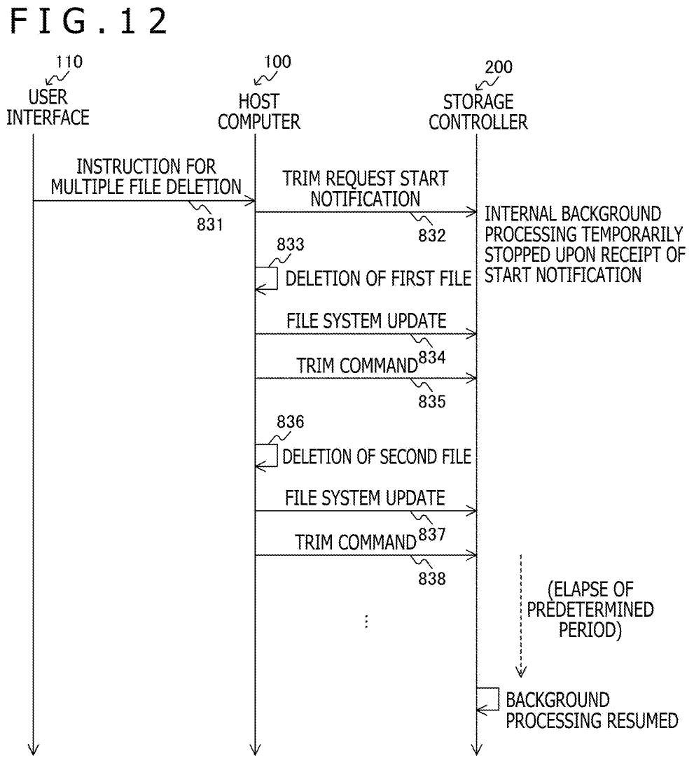

FIG. 12 is a sequence chart illustrating an example flow of overall processing in the third embodiment of the present technology.

When the instruction for multiple file deletion is issued (831), the operations (832 to 838) of the host computer 100 in third embodiment are similar to the operations (822 to 828) in the second embodiment described above. However, as is the case with the operations (813 to 818) in the first embodiment described above, the operations (832 to 838) are applicable also to a case where the TRIM request start notification is not issued.

Further, when the predetermined period elapses from the point of time of receiving the last TRIM command or TRIM request start notification before the receipt of the TRIM request termination notification, the storage controller 200 according to the third embodiment concludes that the series of TRIM commands are completely issued, and resumes the background processing.

As described above, in the third embodiment of the present technology, the timer 240 counts the elapsed time from the point of time of receiving the last TRIM command or TRIM request start notification. Therefore, even in a case where the TRIM request termination notification cannot be received, the storage controller 200 is able to conclude that the series of TRIM commands are completely issued and to resume the background processing.

It should be noted that the foregoing embodiments represent an example for embodying the present technology and that matters in the embodiments have respective corresponding relations to invention-specifying matters in the appended claims. Similarly, the invention-specifying matters in the appended claims have respective corresponding relations to matters in the embodiments of the present technology that are given the same names as the invention-specifying matters. However, the present technology is not limited to the embodiments and can be embodied by making various modifications to the embodiments without departing from the gist of the present technology.

Moreover, processing procedures described in conjunction with the foregoing embodiments may be regarded as methods including a series of such processing procedures or as programs for causing a computer to execute the series of processing procedures or a recording medium for storing such programs. As the recording medium, for example, a CD (Compact Disc), an MD (MiniDisc), a DVD (Digital Versatile Disc), a memory card, or a Blu-ray (registered trademark) disc may be used.

It should be noted that the advantages described in this specification are merely illustrative and not restrictive. In addition, the present technology can provide advantages other than those described in this specification.

It is to be noted that the present technology is also able to adopt the following configurations.

(1)

A storage controller including:

a control section configured to, until predetermined conditions are met after receiving at least one area release request for a storage, cause the storage to suspend a process on the area release request and to cause the storage to execute the process on the area release request when the predetermined conditions are met.

(2)

The storage controller according to (1) above, in which

upon receiving a release request termination notification on the area release request, the control section concludes that the predetermined conditions are met, and causes the storage to execute the process on the area release request.

(3)

The storage controller according to (1) or (2) above, in which

when a predetermined period elapses after the last receipt of the area release request, the control section concludes that the predetermined conditions are met, and causes the storage to execute the process on the area release request.

(4)

The storage controller according to any one of (1) to (3) above, in which

upon receiving a release request start notification on the area release request, the control section causes the storage to suspend the process on the area release request until the predetermined conditions are met.

(5)

The storage controller according to any one of (1) to (4) above, further including:

a suspension process storage section configured to store the process in the storage that is suspended by the control section.

(6)

The storage controller according to any one of (1) to (5) above, further including:

a management information retention section configured to manage a physical address in the storage, in which

the control section releases a target area in the management information retention section according to the area release request.

(7)

The storage controller according to any one of (1) to (6) above, in which

the control section causes the storage to suspend a process on a non-boundary area around an area to be released upon the area release request, the non-boundary area being inconsistent with a boundary of a management unit of the storage.

(8)

The storage controller according to (7) above, in which

the control section causes the storage to resume the process on the non-boundary area when the predetermined conditions are met.

(9)

The storage controller according to any one of (1) to (8) above, in which

the control section causes the storage to execute a garbage collection process as the process on the area release request, the garbage collection process being a process of collecting currently used areas in the storage and moving the collected areas to another area.

(10)

A storage system including:

a storage; and

a control section configured to, until predetermined conditions are met after receiving at least one area release request for the storage, cause the storage to suspend a process on the area release request and to cause the storage to execute the process on the area release request when the predetermined conditions are met.

(11)

An information processing system including:

a storage;

a control section configured to, until predetermined conditions are met after receiving a plurality of area release requests for the storage, cause the storage to suspend a process on the area release requests and to cause the storage to execute the process on the area release requests when the predetermined conditions are met; and

a host computer configured to, upon receiving an instruction for deleting a plurality of files, delete each of the plurality of files and to issue the plurality of area release requests.

(12)

The information processing system according to (11) above, in which

when the plurality of area release requests is completely issued, the host computer issues a release request termination notification, and

upon receiving the release request termination notification, the control section concludes that the predetermined conditions are met, and causes the storage to execute the process on the area release requests.

### REFERENCE SIGNS LIST

21: Background processing stopped state
22: Background processing execution state
100: Host computer
110: User interface
190: Logical block address list
200: Storage controller
210: Control section
220: Address conversion table
230: Storage section
240: Timer
300: Storage
400: Storage system

1. A storage controller comprising:
a control section configured to, until predetermined conditions are met after receiving at least one area release request for a storage, cause the storage to suspend a process on the area release request and to cause the storage to execute the process on the area release request when the predetermined conditions are met.

2. The storage controller according to claim 1, wherein
upon receiving a release request termination notification on the area release request, the control section concludes that the predetermined conditions are met, and causes the storage to execute the process on the area release request.

3. The storage controller according to claim 1, wherein
when a predetermined period elapses after the last receipt of the area release request, the control section concludes that the predetermined conditions are met, and causes the storage to execute the process on the area release request.

4. The storage controller according to claim 1, wherein
upon receiving a release request start notification on the area release request, the control section causes the storage to suspend the process on the area release request until the predetermined conditions are met.

5. The storage controller according to claim 1, further comprising:
a suspension process storage section configured to store the process in the storage that is suspended by the control section.

6. The storage controller according to claim 1, further comprising:
a management information retention section configured to manage a physical address in the storage, wherein
the control section releases a target area in the management information retention section according to the area release request.

7. The storage controller according to claim 1, wherein
the control section causes the storage to suspend a process on a non-boundary area around an area to be released upon the area release request, the non-boundary area being inconsistent with a boundary of a management unit of the storage.

8. The storage controller according to claim 7, wherein
the control section causes the storage to resume the process on the non-boundary area when the predetermined conditions are met.

9. The storage controller according to claim 1, wherein
the control section causes the storage to execute a garbage collection process as the process on the area release request, the garbage collection process being a process of collecting currently used areas in the storage and moving the collected areas to another area.

10. A storage system comprising:
a storage; and
a control section configured to, until predetermined conditions are met after receiving at least one area release request for the storage, cause the storage to suspend a process on the area release request and to cause the storage to execute the process on the area release request when the predetermined conditions are met.

11. An information processing system comprising:
a storage;
a control section configured to, until predetermined conditions are met after receiving a plurality of area release requests for the storage, cause the storage to suspend a process on the area release requests and to cause the storage to execute the process on the area release requests when the predetermined conditions are met; and
a host computer configured to, upon receiving an instruction for deleting a plurality of files, delete each of the plurality of files and to issue the plurality of area release requests.

12. The information processing system according to claim 11, wherein
when the plurality of area release requests is completely issued, the host computer issues a release request termination notification, and
upon receiving the release request termination notification, the control section concludes that the predetermined conditions are met, and causes the storage to execute the process on the area release requests.
